(19) United States
(12) Patent Application Publication
(10) Pub. No.: US 2011/0177419 A1
(43) Pub. Date: Jul. 21, 2011

(54) Fuel cell separator plate

(76) Inventors: Warren L. Luoma, Manchester, CT (US); Robert P. Roche, Cheshire, CT (US); Richard D. Breault, North Kingstown, RI (US); Sridhar V. Kanuri, Milford, CT (US); Kishore Kumar Tenneti, Manchester, CT (US)

(21) Appl. No.: 12/930,633

(22) Filed: Jan. 11, 2011

Related U.S. Application Data
(63) Continuation-in-part of application No. 12/856,732, filed on Aug. 16, 2010.
Application No. 12/856,732 is a continuation of application No. 11/718,336, filed on May 1, 2007, now abandoned.

(51) Int. Cl. H01M 2/16; H01M 8/04; H01M 8/00

(52) U.S. Cl. 429/457; 429/535

(57) ABSTRACT

A fuel cell separator plate assembly (20, 20a) includes a separator layer (22, 22a) and one or more reactant flow field layers (24, 24a, 26, 26a) comprising graphite flakes and a thermoplastic, hydrophobic resin which secures flow field layers on opposite sides of the separator layer. In another example, a separator plate assembly (20a) comprises a monolithic structure in which the separator portion (22a) and the flow field portions (24a, 26a) are all formed in a single piece of the same material. A method heats thermoplastic resin to its point of complete melting, then cools to its point where melting begins, increasing both electric and thermal conductivity. Methods include bonding under higher pressure than previously used, about 800 psi, or under pressures about 750 psi.

### CROSS REFERENCE TO RELATED APPLICATIONS

This application is a continuation in part of U.S. patent application Ser. No. 12/856,732 filed Aug. 16, 2010, in turn a continuation of U.S. patent application Ser. No. 11/718,336 filed May 1, 2007, now abandoned.

### TECHNICAL FIELD

Layered and monolithic fuel cell bipolar separator plates and methods for making them are disclosed and claimed herein.

### BACKGROUND ART

In fuel cells, an anode and a cathode operate in a known manner to produce electrical energy and water under appropriate operating conditions. The cathode and anode are typically separated by a separator plate that is electrically conductive to conduct electrons and isolates the electrolyte (in fuel cells using a liquid electrolyte, such as phosphoric acid) and reactants of adjacent cathodes and anodes.

Traditionally, separator plates have been bonded to a cathode flow field plate of one cell and the anode flow field plate of an adjacent cell. Typical bonding methods include fluorocarbon films to bond separator plates made of carbon. Typical flow field plates are made of carbon-carbon composites. In most arrangements, the flow field plates are porous and hydrophilic so that they serve as a liquid electrolyte reservoir plate in which excess electrolyte can be stored in a known manner.

There are recognized drawbacks associated with such arrangements. One improvement is shown in U.S. Pat. No. 5,558,955, which introduces a cathode flow field plate, formed of graphite flakes and a fluorocarbon resin that is essentially non-porous and hydrophobic. The arrangement disclosed in that patent, which is incorporated herein by reference, represents an improvement over the traditional carbon-carbon flow field plates on both sides of the carbon separator plate.

Those skilled in the art are always striving to make improvements. For example, it would be advantageous to provide a more cost-effective fuel cell separator plate that promotes improved performance.

### SUMMARY

The modality herein provides an improved separator plate that avoids the shortcomings and drawbacks of traditional arrangements and enhances the economies associated with such separator plates.

An exemplary separator plate for use in a fuel cell includes a separator portion, which may be a layer. A first non-porous, hydrophobic flow field portion, which may be a layer, includes a thermoplastic, hydrophobic resin that secures the first flow field portion to a first side of the separator portion. A second non-porous, hydrophobic flow field portion, which may be a layer, includes a thermoplastic, hydrophobic resin that secures the second flow field portion to a second side of the separator portion.

In one example, the first and second flow field portions comprise natural graphite flakes and a thermoplastic, hydrophobic resin.

In one example, the separator portion comprises graphite and a thermoplastic, hydrophobic resin. In this example, the thermoplastic, hydrophobic resin of the separator portion also serves to secure the flow field portions to the opposite sides of the separator portion.

In another example, the separator portion is a carbon separator portion.

Another exemplary separator plate assembly for use in a fuel cell includes a separator layer comprising graphite and thermoplastic, hydrophobic resin. First and second flow field layers are respectively secured to opposite sides of the separator layer by at least the thermoplastic, hydrophobic resin of the separator layer. In one example, at least one of the flow field layers comprises graphite and a thermoplastic, hydrophobic resin. In another example, at least one of the flow field layers is a porous graphite. In another example, both flow field layers comprise graphite and a thermoplastic, hydrophobic resin.

In another example, the separator plate is a monolithic structure, defined herein as having a uniformly consistent, substantially homogeneous material composition throughout the entire separator plate. In such an example, there is no material demarcation between the separator portion and the flow field portions.

An exemplary method of making a separator plate assembly for use in a fuel cell includes forming a separator layer. At least one non-porous, hydrophobic flow field layer is formed using graphite and a hydrophobic resin. The exemplary method includes securing the flow field layer to the separator layer using at least the hydrophobic resin of the flow field layer.

In some examples, forming the separator layer includes using graphite and a thermoplastic, hydrophobic resin. In such examples, the thermoplastic, hydrophobic resin of the separator layer and the thermoplastic, hydrophobic resin of the flow field layer secure the two layers together.

An advantageous method for making separator plates provides about 53% reduction in electrical resistance while improving thermal conductivity by about 7.6%. Increasing both electrical and thermal conductivity provides substantial improvement in performance. In this advantageous method, the flake graphite and thermoplastic, hydrophobic resin are compacted (for instance, at around 4,000 psi), the compacted material is then heated under a lesser pressure to approximately the temperature at which melting of the thermoplastic, hydrophobic resin is complete, and, held at or near the lesser pressure while cooling the material to approximately the temperature at which melting of the thermoplastic, hydrophobic resin begins, or below. For FEP, the temperatures at which melting begins and ends are approximately 400 F and 550 F, respectively. Improved separator plates are obtained by using molding pressures about 800 psi.

Other variations will become more apparent in the light of the following detailed description of exemplary embodiments, as illustrated in the accompanying drawings.

### BRIEF DESCRIPTION OF THE DRAWINGS

FIG. 1 is a diagrammatic, perspective illustration of an exemplary separator plate assembly designed according to an embodiment of the disclosed modality.

FIGS. 2A-2C schematically illustrate an exemplary method of making a separator plate assembly designed according to an embodiment of the disclosed modality.

FIG. 3 is a fragmentary, fanciful, perspective illustration of the exemplary separator plate assembly of FIG. 1 after the layers of the assembly have been bonded by melting the hydrophobic resin under pressure and resolidification, according to an embodiment of the disclosed modality.

FIG. 4 is a fragmentary, fanciful, perspective illustration of a monolithic separator plate assembly having a uniformly homogeneous composition throughout, according to an embodiment of the disclosed modality.

FIG. 5 is a graph of heat flow consumed by FEP resin as a function of temperature.

### MODE(S) OF IMPLEMENTATION

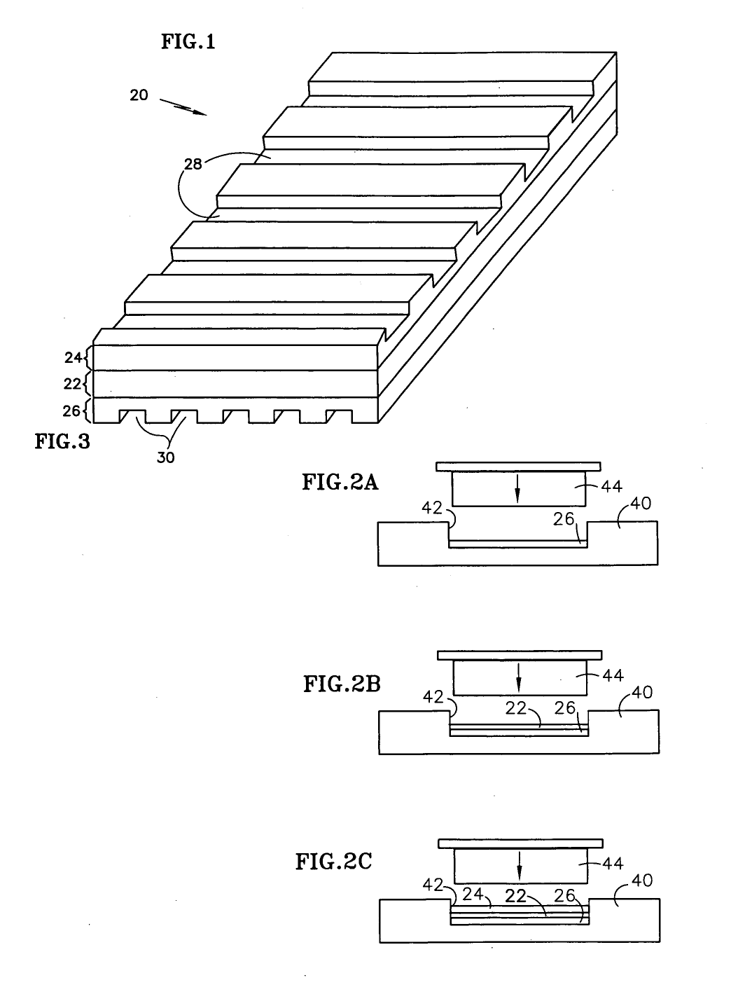

FIG. 1 shows a separator plate assembly 20 that is useful in fuel cells. The exemplary separator plate assembly 20 includes a separator layer 22. A first flow field layer 24 is secured to one side of the separator layer 22. A second flow field layer 26 is secured to a second, oppositely facing side of the separator layer 22.

The flow field layers 24 and 26 each include flow channels 28, 30 that are formed into the flow field layers in a known manner. For example, the flow field channels may be machined into the assembly after bonding, or molded into the flow field layers during the molding process. The channels are preferably arranged in a perpendicular orientation relative to each other as is shown in FIG. 1.

The materials selected for forming the different layers of the separator plate assembly 20 may vary to meet the needs of a particular situation. Several unique combinations are disclosed as exemplary embodiments.

In one example, the separator plate layer 22 comprises graphite and a thermoplastic, hydrophobic resin. In one example, the graphite comprises natural graphite flakes and the hydrophobic resin comprises a thermoplastic, fluorocarbon resin. The natural graphite flakes in one example are thermally purified such as grade SGC 2900 obtained from Superior Graphite Company of Chicago, Ill. to minimize corrosion of the graphite. One exemplary fluorocarbon resin is commercially available from the DuPont Company and is sold under the trade name FEP TEFLON®. PFA and PTFE TEFLONs® are also suitable.

One exemplary separator plate layer 22 comprises between 70% and 80% graphite flakes and a corresponding, remaining percentage of the thermoplastic, hydrophobic resin. One preferred example includes 25% thermoplastic, hydrophobic resin and 75% graphite flakes.

One advantage to using graphite and a thermoplastic, hydrophobic resin for forming a separator layer 22 is that the thermoplastic, hydrophobic resin within the separator layer 22 can be used for securing one or more of the flow field layers 24, 26 to the separator layer 22. Such an arrangement eliminates intermediate films between the layers during a manufacturing process, which provides cost savings from both a material and a labor standpoint.

Another exemplary separator plate assembly includes the separator layer 22 formed of graphite and a thermoplastic, hydrophobic resin. At least one of the flow field layers 24, 26 comprises graphite and a thermoplastic, hydrophobic resin. A different mixing ratio of graphite and hydrophobic resin is used for the flow field layer compared to the separator layer. In one example, the flow field layer 24 comprises approximately 11% FEP TEFLON® hydrophobic resin and approximately 89% flake graphite. The separator layer 22 in that example comprises 75% graphite and 25% FEP TEFLON®.

In another example, one of the flow fields comprises porous graphite. In one example, the separator layer 22 comprises 75% graphite and 25% resin, the flow field layer 26 comprises 89% flake graphite and the flow field layer 24 comprises porous graphite.

It is desirable to use a higher concentration of hydrophobic resin in the separator layer 22 to achieve a sufficiently low rate of hydrogen diffusion across the separator layer. Further, a sufficiently high hydrophobic resin content in the separator layer 22 provides a sufficiently low rate of acid absorption and acid transfer through the separator plate. A separator layer designed according to an embodiment of this modality provides uniquely low acid transfer rates compared to previous arrangements.

In one example, both of the flow field layers 24, 26 are formed using graphite and a thermoplastic, hydrophobic resin. With such an arrangement, the hydrophobic resin of each layer is used to bond that layer to the corresponding adjacent layer. Using the hydrophobic resin of at least one of the layers to secure that layer to the next layer eliminates the requirement of using separate films, resins or adhesives for securing the various layers together.

In one example, the separator layer 22 also comprises graphite and a thermoplastic, hydrophobic resin. The thermoplastic, hydrophobic resin may be any thermoplastic resin which is chemically and physically compatible with the operating environment of the fuel cell and has a surface energy of less than about 25 DYNE/cm.

One exemplary assembly includes a separator layer 22 comprising between about 15% and about 30% TEFLON@ FEP TE 9050 available from the DuPont Company. A remaining, corresponding percentage of thermally purified flake graphite grade #2901C from the Superior Graphite Company completes the formulation of the separator layer 22. In one preferred example, approximately 25% of the TEFLON@ FEP hydrophobic resin is used with approximately 75% flake graphite. This preferred formulation provides a thermal conductivity of 4.2 BTU/hr/ft/F, an electrical resistance that results in a voltage drop of 0.055 mV per mil of thickness at a current of 100 AMPS per square foot (ASF), a porosity of approximately 2%-3%, a median pore size of 0.005 micrometers, a surface energy of approximately 35 Dynes/cm, a coefficient of thermal expansion of approximately 5-10 ppm/F and a corrosion current at 1150 mV for 100 minutes of approximately 0.5 uA/mg in 100% H₃PO₄ at 400 F.

In another example, the two flow field layers 24, 26 each comprise graphite and thermoplastic, hydrophobic resin. The separator layer 22 comprises carbon and is formed as a traditional separator layer, such as that produced by Showa Denko Carbon Inc., Ridgeville, S.C.

Referring to FIGS. 2A-2C, exemplary methods of making such separator plate assemblies include using a mold 40 having a mold cavity 42 and a cooperating plunger 44 to form the various layers of the assembly. As schematically shown in FIG. 2A, the flow field layer 26 can be preformed in the mold 40 by depositing an appropriate amount of the selected material mixture to form the flow field layer 26. For purposes of discussion, the exemplary method to be described includes using graphite and a thermoplastic, hydrophobic resin for all three layers of the separator plate assembly. In this example, an appropriate mixture of graphite and thermoplastic, hydrophobic resin is inserted into the mold cavity 42. The mold plunger 44 compresses the mixture at a suitable pressure, such as 4,000 psi.

As schematically shown in FIG. 2B, a graphite and thermoplastic, hydrophobic resin mixture is then deposited on top of the compacted material of the flow field layer 26 to establish a layer of material to form the separator layer 22. As mentioned above, the graphite-to-resin mixture ratio for the separator plate layer 22 preferably includes a higher amount of the hydrophobic resin to achieve the gas diffusion and acid transfer rates that are advantageous as mentioned above. Once the material for the separator layer 22 is dispensed into the mold cavity 42, the plunger 44 compresses that layer and the flow field layer 26 at a suitable pressure such as 4,000 psi to compact both layers.

As schematically shown in FIG. 2C, a layer of graphite and thermoplastic, hydrophobic resin mixture for the flow field layer 24, in the illustrated example is deposited on top of the compacted material for the separator layer 22. The plunger 44 then compacts all three layers using a suitable pressure such as 4,000 psi.

Once all layers are compacted and adjacent each other in the desired arrangement, the entire assembly is heated in one example to a temperature of approximately 650 F (or in another preferred example, hereinafter, to about 550 F if the resin is FEP), at a pressure of 750 psi (or in another preferred example hereinafter, to about 800 psi), for approximately twenty minutes. The entire assembly is then subsequently cooled at the same pressure to less than the melting point of the resin which is about 400 F if the resin is FEP. Additional cool down to an ambient temperature can be performed at a lower pressure (i.e., less than 750 psi). Heating the assembly melts the thermoplastic, hydrophobic resin and permits it to flow into the voids between the graphite particles. This minimizes the porosity of the layer. Cooling the layer to about 400 F (or below) solidifies the molten thermoplastic resin and causes the graphite particles and layers to bond.

The entire assembly 20 can then be removed from the mold cavity 42 and any release films used on the outward most surfaces of the assembly can then be removed. Flow field channels can then be formed into the flow field layers in a known manner, such as by being machined or otherwise, if mold platens do not include flow field channel configurations. If the flow channels are machined, the waste from machining is normally recycled to reduce costs. It is preferred to use the recycled material for the flow channel layers and new material for the separator layer or for a monolithic separator.

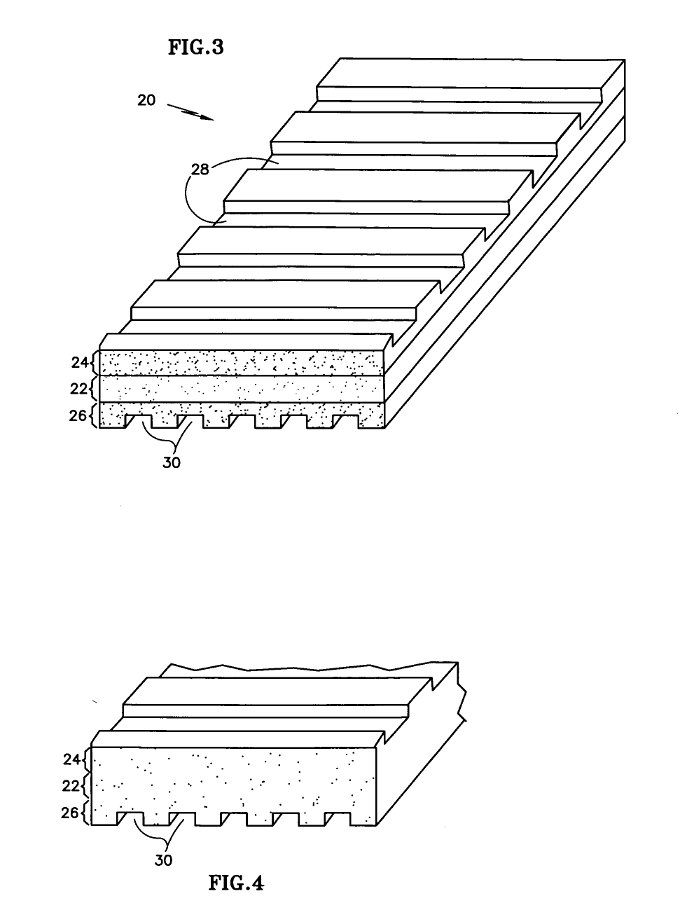

After the fabrication is complete, the separator plate assembly 20 may have a sectional appearance suggested in FIG. 3, in which the fine or light stippling denotes the separator portion and the heavy, darker stippling indicates the fuel flow portions.

In an example where only the separator layer 22 comprises graphite and a hydrophobic resin, the flow field layers 24, 26 may be preformed and the compaction described above may only be needed after depositing the material for the separator layer 22 into the mold cavity.

In another example, the powders for layers 26, 22, 24 are sequentially loaded into the mold without using any compaction at room temperature.

In an example where only one of the flow field layers 24, 26 is to be used, the heating sequence described above may be used after completing the steps schematically shown in FIG. 2B, for example, to provide a subassembly that can then be secured to another flow field layer using known techniques.

In another example, the separator plate assembly 20 is compressed using a double belt press that operates in a known manner.

Providing non-porous, hydrophobic flow field layers on opposite sides of a separator layer, and using a thermoplastic, hydrophobic resin of the flow field layers and/or the separator plate for securing the flow field layers to the separator layer, provides an improved arrangement as described above. Improved performance and cost savings are possible with such an arrangement. Additionally, utilizing a separator layer comprising graphite and a hydrophobic resin provides improved performance and cost savings. A combination of one or more such layers can be used to meet the needs of a particular situation. Those skilled in the art who have the benefit of this description will be able to decide what combination will best work for their situation.

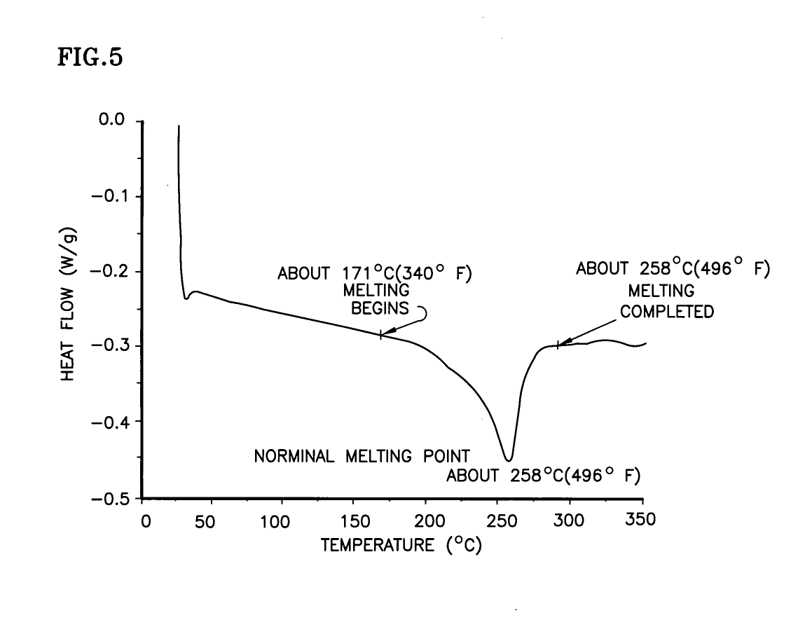

An alternative process results in higher density, lower porosity, and improved electrical conductivity. This process is predicated on the realization that some thermoplastic resins have properties less well suited for fuel cell separator plate and reactant flow fields when heated much beyond the temperature at which melting is complete. The thermoplastic, hydrophobic resins of this modality have a range of molecular weights, ranging from lightest to heaviest. The lightest molecular weight fragments melt at the temperature at which melting begins, then the heaviest molecular weight fragments melt near the temperature at which melting is complete. The melting pattern of DuPont FEP 6100 is illustrated in FIG. 5, which shows that melting begins at about 340 F and is complete at about 550 F. The nominal melting point for FEP 6100 is 258 F.

The improvements which are realized from limiting the bonding temperature to that at which melting is complete is shown in the following table.

| | 650 F., | 550 F., |
|---|---|---|
| Property | 800 psi | 800 psi |
| Density, g/cc | 2.15 | 2.18 |
| Porosity, % | 6.5 | 5.5 |
| Internal resistance, mV/mil | 0.032 | 0.015 |
| Thermal Conductivity, W/m-K | 9.2 | 9.9 |

The superior results include a 53% reduction in electrical resistance which provides a commensurate increase in output power per unit cell. Thermal conductivity is also increased, but to a lesser degree. This promotes better control of cell temperatures, and improves performance as well.

Temperature for one alternative molding process, when the thermoplastic, hydrophobic resin is FEP, may be between about 525 F and about 675 F, and more preferably between about 525 F and about 575 F, and most preferably about 550 F. On the other hand, the temperature where melting is complete for perfluoroalkoxy (PFA) is about 600 F and for polytetrafluoroethylene (PTFE) is about 660 F.

This process may also benefit from use of higher molding pressure than in the foregoing examples. Pressure may range between about 400 psi and about 1200 psi, preferably between about 700 psi and about 900 psi, but most preferably about 800 psi. Thus, an optimum, most preferred parameter set, for bonding when the resin is FEP, is about 550 F and about 800 psi.

Furthermore, although the foregoing processes have described embodiments being bonded in a cavity mold, they may be practiced using flat platens, which provides much easier removal of the molded part or parts, after the bond is complete. Due to flash (extrusion of material at edges), this may require edge trimming. Use of correct amounts of materials and optimum temperature and pressure (above) results in minimal flash and optimal physical properties.

In FIG. 4, another exemplary separator plate 20a includes a monolithic structure where the flow field portions 24a, 26a and the separator portion 22a all have the same, uniform composition and there are no discrete layers or zones in the separator plate. In other words, the monolithic separator plate 20a in this example has a consistent material composition throughout the separator plate and there is no material or physical demarcation between the portions 22a, 24a and 26a.

The exemplary monolithic separator plate 20a comprises flake graphite and a hydrophobic resin. In one example, the monolithic separator plate 20a comprises approximately 15-20% thermoplastic, hydrophobic resin and the balance flake graphite. One preferred composition is 17.5% thermoplastic, hydrophobic resin and the balance thermally purified flake graphite.

A “separator plate” is defined herein as one which separates a fuel cell on one side of it from an adjacent fuel cell on a side of it opposite to said one side; it is sometimes referred to as a “bipolar” plate because it is adjacent to one pole of one fuel cell and to the opposite pole of the adjacent fuel cell.

Since changes and variations of the disclosed embodiments may be made without departing from the concept's intent, it is not intended to limit the disclosure other than as required by the appended claims.

1. A fuel cell separator plate (20, 20a) comprising:
a separator portion (22, 22a);
characterized by:
a first nonporous, hydrophobic flow field portion (24, 24a) comprising flake graphite and a thermoplastic, hydrophobic resin, adjacent a first side of the separator portion; and
a second nonporous, hydrophobic flow field portion (26, 26a) comprising flake graphite and a thermoplastic, hydrophobic resin, adjacent a second side of the separator portion.

2. A separator plate (20, 20a) of claim 1, wherein the thermoplastic, hydrophobic resin secures the flow field portions (24, 26) to the separator portion (22).

3. A separator plate (20, 20a) of claim 1, wherein the graphite comprises natural graphite flakes.

4. A separator plate (20, 20a) of claim 3, wherein the graphite comprises thermally purified natural graphite flakes.

5. A separator plate (20, 20a) of claim 1, wherein the separator portion (22, 22a) comprises a carbon separator portion (22, 22a).

6. A separator plate (20, 20a) of claim 1, wherein the separator portion (22, 22a) comprises the flake graphite and a thermoplastic, hydrophobic resin.

7. A separator plate (20, 20a) of claim 6, wherein the graphite comprises natural graphite flakes.

8. A separator plate (20, 20a) of claim 6, wherein the graphite comprises thermally purified natural graphite flakes.

9. A separator plate (20, 20a) of claim 6, wherein the first and second flow field portions (24, 24a, 26, 26a) comprise a first mixing ratio of flake graphite to hydrophobic resin and the separator portion (122) comprises a second mixing ratio of flake graphite to hydrophobic resin different from said first mixing ratio.

10. A separator plate (20, 20a) of claim 6, wherein the hydrophobic resin has a surface energy less than 25 DYNE/cm.

11. A separator plate (20, 20a) of claim 1 wherein:
the thermoplastic, hydrophobic resin comprises one of FEP, PFA, or PTFE.

12. A separator plate (20) of claim 1, wherein:
each of the portions (22, 24, 26) is a layer distinct from any other portion.

13. A separator plate (20) of claim 12, wherein:
the separator layer (22) comprises flake graphite and a thermoplastic, hydrophobic resin.

14. A separator plate (20) of claim 13, wherein the separator layer (22) comprises between approximately 70% and approximately 80% flake graphite and a corresponding remaining percentage of thermoplastic, hydrophobic resin.

15. A separator plate (20) of claim 14, wherein the separator layer (22) comprises approximately 75% flake graphite and a corresponding remaining percentage of thermoplastic, hydrophobic resin.

16. A separator plate (20) of claim 13, wherein at least one of the flow field layers (24, 26) comprises approximately 89% flake graphite and a corresponding remaining percentage of thermoplastic, hydrophobic resin.

17. A separator plate (20a) of claim 1, wherein the separator plate (20a) is a monolithic structure having a uniformly consistent material composition comprising flake graphite and thermoplastic, hydrophobic resin throughout the separator plate (20a), and there is no material or physical demarcation between the portions (22a, 24a, 26a).

18. A separator plate (20a) of claim 17, wherein each of the portions (22a, 24a, 26a) comprises between approximately 15% and approximately 20% thermoplastic, hydrophobic resin, and a corresponding remaining percentage of flake graphite.

19. A separator plate (20a) of claim 18, wherein each of the portions (22a, 24a, 26a) comprises approximately 17.5% thermoplastic, hydrophobic resin, and a corresponding remaining percentage of flake graphite.

20. A separator plate (20, 20a) for use in a fuel cell, comprising:
a separator portion (22, 22a) comprising flake graphite and a thermoplastic, hydrophobic resin; and
first and second flow field portions (24, 24a, 26, 26a) respectively adjacent opposite sides of the separator portion.

21. A separator plate (20, 20a) of claim 20, wherein the hydrophobic resin has a surface energy less than about 25 DYNE/cm.

22. A separator plate (20) of claim 20, wherein:
each of the portions (22, 24, 26) is a layer distinct from any other portion.

23. A separator plate (20) of claim 22, wherein at least one of the flow field layers (24, 26) is porous and comprises graphite.

24. A separator plate (20) of claim 22, wherein the flow field layers (24, 26) are secured to the separator layer (22) by at least the thermoplastic, hydrophobic resin of the separator layer.

25. A separator plate (20) of claim 22, wherein at least one of the first and second flow field layers (24, 26) is nonporous, hydrophobic and comprises flake graphite and a thermoplastic, hydrophobic resin.

26. A separator plate (20) of claim 25, wherein the at least one flow field layer (24, 26) comprises a first mixing ratio of graphite to hydrophobic resin and the separator layer (22) comprises a second mixing ratio of graphite to hydrophobic resin different from said first mixing ratio.

27. A separator plate (20) of claim 22, wherein each of the flow field layers (24, 26) comprises between approximately 70% and approximately 80% flake graphite and a corresponding remaining percentage of thermoplastic, hydrophobic resin.

28. A separator plate (20) of claim 27, wherein each of the flow field layers (24, 26) comprises approximately 75% flake graphite and a corresponding remaining percentage of thermoplastic, hydrophobic resin.

29. A separator plate (20a) of claim 20, wherein the separator plate (20a) is a monolithic structure having a uniformly consistent material composition comprising flake graphite and a thermoplastic, hydrophobic resin throughout the separator plate, and there is no material or physical demarcation between the portions (22a, 24a, 26a).

30. A separator plate (20a) of claim 29, wherein each of the portions (22a, 24a, 26a) comprises between approximately 15% and approximately 20% thermoplastic, hydrophobic resin, and a corresponding remaining percentage of flake graphite.

31. A separator plate (20a) of claim 30, wherein each of the portions (22a, 24a, 26a) comprises approximately 17.5% thermoplastic, hydrophobic resin and a corresponding remaining percentage of flake graphite.

32. A method of making a separator plate assembly (20) for use in a fuel cell, comprising:
forming a separator layer (22);
forming one or more flow field layers (24, 26);
using flake graphite and a thermoplastic, hydrophobic resin for forming at least one of the separator layer or the one or more flow field layer such that the at least one layer is nonporous and hydrophobic; and
securing the one or more flow field layers to the separator layer using the thermoplastic, hydrophobic resin.

33. The method of claim 32, including using flake graphite and a thermoplastic, hydrophobic resin for forming the one or more flow field layers (24, 26) and the separator layer (22), and securing the one or more flow field layer to the separator layer using the thermoplastic, hydrophobic resins of the separator layer and the one or more flow field layer.

34. A method of making a separator plate assembly (20) for use in a fuel cell, comprising:
compacting flake graphite and thermoplastic, hydrophobic resin for forming a first one of one or more flow field layers (24, 26);
compacting additional flake graphite and thermoplastic, hydrophobic resin for forming a separator layer (22) adjacent the compacted material of the first one or more flow field layers; and
under pressure, heating and thereafter cooling the compacted materials to secure the separator layer to the flow field layer.

35. The method of claim 34 wherein:
the compacted materials are heated under pressure to approximately the temperature at which melting of the thermoplastic, hydrophobic resin is complete.

36. The method of claim 35 wherein:
after heating the compacted materials to approximately the temperature at which melting of the thermoplastic, hydrophobic resin is complete, cooling the compacted materials to approximately the temperature at which melting of the thermoplastic, hydrophobic resin begins, or below.

37. The method of claim 34 wherein:
the thermoplastic, hydrophobic resin is selected from FEP. PFA or PTFE.

38. The method of claim 37 wherein:
the thermoplastic, hydrophobic resin is FEP; and
the compacted materials are heated to between approximately 525 F and approximately 575 F.

39. The method of claim 37 wherein:
the compacted materials are heated to approximately 550 F.

40. The method of claim 34, including:
compacting additional flake graphite and thermoplastic, hydrophobic resin for forming a second nonporous, hydrophobic flow field layer (24, 26) on an opposite side of the compacted separator layer (22) prior to the heating; and
heating and thereafter cooling the compacted materials to secure the two flow field layers to the separator layer using the thermoplastic, hydrophobic resins of the separator layer and the flow field layers, respectively.

41. The method of claim 40 wherein:
the compacted materials are heated to approximately the temperature at which melting of the thermoplastic, hydrophobic resin is complete.

42. The method of claim 41 wherein:
after heating the compacted materials to approximately the temperature at which melting of the thermoplastic, hydrophobic resin is complete, cooling the compacted materials approximately the temperature at which melting of the thermoplastic, hydrophobic resin begins, or below.

43. The method of claim 41 wherein:
the thermoplastic, hydrophobic resin is FEP; and
the compacted materials are heated to between approximately 525 F and approximately 575 F.

44. The method of claim 43 wherein:
the compacted materials are heated to approximately 550 F.

45. The method of claim 34 wherein:
the heating step is carried out while applying a pressure to all of the layers (22, 24, 26) of between approximately 400 psi and approximately 1200 psi.

46. The method of claim 45 wherein:
the heating step is carried out while applying a pressure to all of the layers (22, 24, 26) of between approximately 700 psi and approximately 900 psi.

47. The method of claim 46 wherein:
the heating step is carried out while applying a pressure to all of the layers (22, 24, 26) of approximately 800 psi.

48. The method of claim 34 wherein:
the materials are compacted at approximately 4000 psi before heating.

49. The method of claim 34 including:
forming flow field channels into the flow field layers.

50. A method of making a separator plate (20, 20a) for use in a fuel cell, comprising:
compacting flake graphite and thermoplastic, hydrophobic resin;
heating and thereafter cooling the compacted materials under pressure to form the separator plate.

51. The method of claim 50 wherein:
the compacted materials are heated to approximately the temperature at which melting of the thermoplastic, hydrophobic resin is complete.

52. The method of claim 51 wherein:
after heating the compacted materials to approximately the temperature at which melting of the thermoplastic, hydrophobic resin is complete, cooling the compacted materials to approximately the temperature at which melting of the thermoplastic, hydrophobic resin begins, or below.

53. The method of claim 51 wherein:
the thermoplastic, hydrophobic resin is selected from FEP, PFA or PTFE.

54. The method of claim 53 wherein:
the thermoplastic, hydrophobic resin is FEP; and
the compacted materials are heated to between approximately 525 F and approximately 575 F.

55. The method of claim 53 wherein:
the compacted materials are heated to approximately 550 F.

56. The method of claim 52 wherein:
the compacted materials are first made into a separator layer (22) and a pair of separate flow field layers (24, 26);
the layers are heated under pressure to secure the two flow field layers on opposite sides of the separator plate layer; and
thereafter, the compacted materials are cooled.

57. The method of claim 50 comprising:
compacting flake graphite and thermoplastic, hydrophobic resin into a monolithic separator plate (20, 20a) having a uniformly consistent material composition comprising flake graphite and a thermoplastic, hydrophobic resin throughout the separator plate, and there is no material or physical demarcation between portions thereof.

58. The method of claim 50 including:
forming flow field channels on opposite major surfaces of the separator plate.

59. A separator plate made by a method according to claim 36.

60. A separator plate made by a method according to claim 46.

61. A separator plate made by a method according to claim 57.

62. A separator plate made by a method according to claim 58.
